(19) United States
(12) Patent Application Publication
(10) Pub. No.: US 2026/0001818 A1
(43) Pub. Date: Jan. 1, 2026

(54) METHOD OF REDUCTION CORROSION OF REINFORCED CARBONATED CONSTRUCTION ELEMENTS

(71) Applicant: Amrize Technology Switzerland LLC, ZUG (CH)

(72) Inventors: Bruno HUET, HOLDERBANK (CH); Vincent BRIAUD, HOLDERBANK (CH); Edelio BERMEJO, HOLDERBANK (CH)

(21) Appl. No.: 18/992,451

(22) PCT Filed: Jul. 12, 2023
(86) PCT No.: PCT/EP2023/069385

§ 371 Date: Jan. 8, 2025

(30) Foreign Application Priority Data
Jul. 12, 2022 (EP) 22306050.0

(51) Int. Cl. C04B 40/02; C04B 14/48; C04B 24/04; C04B 24/10; C04B 24/12; C04B 24/42; C04B 28/04; C04B 40/00; C04B 103/10; C04B 103/20; C04B 103/61; C04B 111/00; C04B 111/26

(52) U.S. Cl. CPC C04B 40/0231; C04B 14/48; C04B 24/04; C04B 24/10; C04B 24/122; C04B 24/42; C04B 28/04; C04B 40/0071; C04B 40/0082; C04B 40/0281; C04B 2103/10; C04B 2103/20; C04B 2103/61; C04B 2111/00019; C04B 2111/26

(57) ABSTRACT

A method of preparation of a reinforced carbonated construction element, includes a) preparing a composition containing a cement, metal reinforcing elements, water and hydrophobic additives; then b) a carbonation of the composition in presence of CO₂ gas having a CO₂ content higher than 500 ppm, wherein the composition includes more than 0.05% in weight, compared to the total weight of the cement, of hydrophobic additive.

### BACKGROUND

The present disclosure relates to methods of making Ordinary Portland Cement (OPC) reinforced carbonated construction elements, for reducing the greenhouse gas emissions associated with making concrete construction elements, for sequestering carbon dioxide while preventing corrosion of metal reinforcing elements.

In concrete compositions which have just been casted, and therefore have not been naturally carbonated, the pH typically lies between 12 and 13. At this pH value, metal elements within the concrete volume, used for example for reinforcing the concrete and increasing the flexural strength, passivates.

Passivation of the metal reinforcing elements results in the formation of a layer of metal oxides, such as iron oxides Fe₂O₃ or Fe₃O₄, onto the surface of metal. Metal oxides are insoluble in a high pH environment, and therefore isolate the core of metal reinforcing elements from its environment, thus protecting the metal from corrosion.

The destruction of the passivation layer can be indirectly caused by natural carbonation of concrete. When a concrete element is exposed to air, carbon dioxide then is able to dissolve in the pore solution of the concrete, i.e. the residual water that is present in the pores of concrete. This process leads to the formation of calcium carbonate and dissolution of phases buffering the pH of the pore solution. Eventually the pH decreases down to neutral pH (8 to 9) from 13. This in turn results in the dissolution of the metal oxides of the passivation layer, which form metal hydroxides. This process continues until the passivation layer is completely destroyed. As a final consequence, pitting of the reinforced concrete structure occurs, which continues until a hole is created in the concrete. Such a mechanism is further accelerated in the presence of chloride ions. But natural carbonation of concrete is a very slow process and thus destruction of the passivation layer protecting metal from corrosion takes decades to occur.

Accelerate carbonation of concrete materials is increasingly being investigated as a method to sequestrate carbon dioxide from the atmosphere. For example, WO2015/112655, EP 3 687 960, EP 3 362 237 relate to the special binders, concrete compositions, and accelerate carbonation processes that maximize the sequestration of carbon dioxide in construction materials.

During his research (WO2022/268869), applicants have developed an improved method for carbonating of cement compositions comprising specific combination of chemical additives.

Under accelerate carbonation, the pH of carbonated concrete reduces to levels that would trigger a corrosion of metal reinforcing elements. Contrary to natural carbonation, the corrosion can appear relatively quickly. Hence, carbonated concrete can only be used in limited applications, where no concrete reinforcement elements are required, such as small concrete elements and pavers. Structural concrete, which represents a large portion of the volumes of concrete used in the market, cannot be produced with carbonated concrete, which limits the capacity of concrete to be used as a material to sequestrate carbon dioxide.

An alternative could in practice be to replace metal reinforcing elements with materials that do not corrode, such as fiber glass. However, the costs associated are prohibitive.

The present invention solves these issues by providing a method for preparing reinforced carbonated concrete construction elements in which the corrosion of metal reinforcing elements is prevented. The corrosion rates are lowered to levels that are suitable for a service life of structural concrete of 50 to 100 years.

Surprisingly, the inventors found that the use of hydrophobic additive in cement, i.e. mixed within the cement composition, prevents the corrosion of metal reinforcing element and enhances the service life of construction element.

### SUMMARY OF THE INVENTION

The present invention relates to a method for preventing corrosion of metal reinforcing element and storing carbon dioxide in a construction element, comprising the consecutive steps of:
a) preparing a composition containing a cement, metal reinforcing elements, water and hydrophobic additive;
b) a carbonation step of the composition in presence of CO₂ gas having a CO₂ content higher than 500 ppm,
   characterized in that the composition of step a) comprises more than 0.01% in weight, compared to the total weight of the cement, of hydrophobic additive.

The hydrophobic additive is mixed with the cement and is thus dispersed within the cement composition. The cement and the hydrophobic additive can be mixed prior to be introduced into step a) or during step a).

Preferably, the method comprises after the carbonation step b), a final drying step performed at a temperature ranging from 40° C. to 115° C.

Preferably, the hydrophobic additive content ranges from 0.01% to 15% by weight, preferentially from 0.05% to 10% by weight, preferentially from 0.1% to 5% and more preferentially from 0.5% to 2% by weight of the total weight of the cement.

Preferably, the hydrophobic additive is selected from silane, polysiloxane, salt of fatty acid or mixtures thereof.

Preferably, the composition further comprises a cement hydration retarder, preferably more than 0.05% in weight of the cement hydration retarder, preferably more than 0.05% to 6%, the percentages are expressed in weight compared to the total weight of the cement, preferably the cement hydration retarder is selected from sodium gluconate, Amino Tris Methylene Phosphonic acid (ATMP), saccharose, or Ethylene Diamine Tetraacetic acid (EDTA), or mixtures thereof.

Preferably, the composition further comprises a cement carbonation accelerator selected from triethylamine, triisopropanolamine, calcium salts, sodium salts, or mixtures thereof, the composition comprises from 0.01% to 6% of the carbonation accelerator, the percentages are expressed in weight compared to the total weight of the cement.

Preferably, the cement comprises at least 20%, preferentially 50%, in weight compared to the total weight cement, of Portland clinker, preferably the cement is selected from a CEM I or a CEM III.

Preferably, the composition of step a) has a weight water/cement ratio below 0.8, preferably below 0.7, preferably below 0.6.

Preferably, the composition of step a) is submitted to a pre-drying step. One understands that the pre-drying step is performed prior to step b).

Preferably, pre-drying step is conducted at a temperature ranging from 20 to 80° C. and at a controlled relative humidity, ranging from 10 to 95%, preferably pre-drying step is conducted until the composition has a water content ranging from 0.1 to 0.3, preferably from 0.1 to 0.2.

Preferably, during the carbonation step, one or many of the following conditions are satisfied:
the temperature is ranging from 20° C. to 100° C., preferably from 40° C. to 90° C.;
the pressure is ranging from 600 hPa to 4 200 hPa, preferably from 700 hPa to 3 500 hPa;
the relative humidity is above 80° %, preferably above 90° % and preferably the relative humidity can be until 100% at the temperature and pressure of step b).

Preferably, step b) is carried out in a chamber of an incubator:
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure or with slight overpressure, the relative humidity within the chamber of the incubator is above 80° % and the temperature within the chamber of the incubator is ranging from 20° C. to 80° C.

Advantageously, hardening of the cement composition is performed simultaneously to carbonation during step b).

The invention is also directed to the use of hydrophobic additive, preferably selected from silane, polysiloxane, salt of fatty acid or mixtures thereof, for preventing corrosion of metal reinforcing element after accelerated carbonation in a construction element prepared by a method according to the invention.

The invention is also directed to a method for preventing corrosion of metal reinforcing element and storing carbon dioxide in a construction element, comprising the consecutive steps of:
a) preparing a composition containing a cement, metal reinforcing elements, water and hydrophobic additive;
b) submitting the composition to a carbonation step in presence of CO₂ gas having a CO₂ content higher than 500 ppm,
   characterized in that the composition of step a) comprises more than 0.01% in weight, compared to the total weight of the cement, of hydrophobic additive.

The above and other objects, features and advantages of this invention will be apparent in the following detailed description.

### FIGURES

FIGS. 1a to 1c are a schematic representation of the samples of the examples with the position of the electrodes in mold having a size of 7*7*28 cm. A complete description of the FIGS. 1a to 1c is done in the example part.

FIG. 2 is the histogram representation of the Icorr values of the corrosion measurement after 1 day of immersion at cycle 2 (see table 4) for sample 1 or 2 or 3 disclosed in the examples.

FIG. 3 is the histogram representation of the Icorr values of the corrosion measurement after 1 day of drying at cycle 2 (see table 4) for sample 1 or 2 or 3 disclosed in the examples.

### DEFINITIONS

Cement: a cement is a hydraulic binder comprising at least 50% by weight of 100 (CaO) and silicon dioxide (SiO₂), in weight compared to the total weight of the cement. The cement is preferably a cement as defined in the standard NF-EN-197-1 of April 2012. The cements defined in standard NF-EN197-1 of April 2012 are grouped in 5 different families: CEM I, CEM II, CEM III, CEM IV and CEM V. The cement preferably comprises at least 95%; in weight compared to the total weight of the cement, of main constituent selected from the group consisting of Portland clinker and combinations of Portland clinker with mineral component.

Mineral component: The mineral component comprises one or at least one of the components that are defined in paragraphs 5.2.2 to 5.2.7 of the same standard NF-EN197-1 of April 2012. Accordingly, the mineral component is selected from the group consisting of granulated blast furnace slag, pozzolanic materials, fly ashes, burnt shale, limestone, silica fume and combinations thereof. CO₂ containing gas: a gas that contains a minimum of 5% in volume of CO₂ compared to the total volume of the dry gas composition. The terms “CO₂ gas” can also be used. “CO₂ gas” also means a gas that contains a minimum of 5% in volume of CO₂ by volume of total dry gas.

Constant CO₂ concentration: variations of the CO₂ concentration in the chamber of the incubator are kept below 10% of a reference value during the whole carbonation step. The CO₂ concentration in the chamber can be controlled or measured by using a CO₂ flow meter and/or a CO₂ concentration meter. The CO₂ meter can be inside or outside the chamber. Preferably, the CO₂ concentration in the chamber can be measured, preferably continuously or periodically, by using dedicated CO₂ sensors such as infrared CO₂ meter. Preferably, the measurement is carried out continuously.

A carbonation corresponds to any process which allows to sequester quickly CO₂ within cementitious structures by contacting said structures with a gas stream containing carbon dioxide (CO₂) or a mixed stream that includes carbon dioxide and steam since the CO₂ content is higher than 500 ppm. Such carbonation, also called accelerated carbonation, does not encompass natural carbonation.

### DETAILED DESCRIPTION

It was discovered that the use of hydrophobic additive in a concrete composition for carbonated reinforced construction element prevents the corrosion of metal reinforcing element.

The method of the invention allows the use of standard OPC that complies with the definition given in the standard EN 197-1 of April 2012.

Accordingly hydrophobic additive can be used in a concrete composition for carbonated reinforced construction element, said composition comprising cement, metal reinforcing element and more than 0.01% in weight, compared to the total weight of the cement, of the hydrophobic additive for preventing corrosion of metal reinforcing element after accelerated carbonation. Advantageously, hydrophobic additive prevents corrosion of metal reinforcing elements of a concrete composition in a carbonated reinforced construction element.

Thus, the invention is directed to a method of preventing corrosion of metal reinforcing element in a reinforced carbonated construction element, comprising the consecutive steps of:
a) preparing a composition containing a cement, metal reinforcing elements, water and hydrophobic additive;
b) submitting the composition of step a) to a carbonation step in presence of CO₂ gas having a CO₂ content higher than 500 ppm,
   characterized in that the composition of step a) comprises more than 0.01% in weight, compared to the total weight of the cement, of hydrophobic additive.

The mass of composition obtained by the method increases, compared to the initial mass of the composition prior to step b) due to CO₂ uptake notably during the carbonation. H₂O uptake can also participate in the increase of the mass. The method of measurement of hydration and carbonation amount is disclosed in the examples and can be applied generally to any composition obtained by the disclosed method.

The CO₂ uptake is the value Δm_{CO2} calculated according to the equation 5 disclosed in the examples.

The present method allows to prevent the corrosion of the metal reinforcing elements while sequestering CO₂, preferably with a CO₂ uptake greater than 0.15.

The corrosion of the metal reinforcing elements is measured by controlling the resistivity as disclosed in the examples.

Thus, the method involves the addition to the reinforced cement composition of a hydrophobic additive that prevents the corrosion of the metal reinforcing elements after carbonation.

The hydrophobic additive is mixed with the cement and is thus dispersed within the cement composition. In an embodiment, the additive is mixed with the cement prior to the preparation of the concrete composition. Thus, cement and hydrophobic additive are mixed prior to be introduced into step a). In this embodiment, a pre-mixed cement is thus specially produced to be used for making concrete composition for a carbonated reinforced construction element.

In an embodiment, the additive is mixed together with all the other constituents of the concrete composition, for example in a ready-mix concrete production plant. Thus, hydrophobic additive is mixed with cement for preparing the composition during step a).

The method can also involve the addition to the cement composition of a hydration retarder that prevents or limits the reinforced composition from hardening without CO₂ addition. Once CO₂ is added, the reinforced composition containing cement will harden by carbonation of the cement.

### Step a): Preparing a Composition

The composition of step a) is preferably selected from a cement paste, a mortar, or a concrete.

Preferably, metal reinforcing element which is placed within concrete or mortar for various purposes including, but not limited to, structural purposes and shall expressly include, but not be limited to, reinforcing bars, grills, beams, metallic fibers, metal deck hold downs and wire mesh.

Preferably, metal reinforcing elements are made of iron, steel, copper, galvanized steel, tin plated steel or other structurally suitable metals by introducing into concrete.

Hydrophobic additive according to the invention is an additive lowering water ingress by capillary flow and/or the water content in equilibrium at a given relative humidity (RH). The water ingress is measured according to the protocol of ISO 15148:2002.

Advantageously, the composition comprises hydrophobic additive selected from silane, polysiloxane, salt of fatty acid or mixtures thereof.

The polysiloxane may be a polysiloxane derivative whose repetitive unit is of the general formula (I): (R₂SiO)ₙ where n is a number from 1 to 70, R, identic or different, is selected from the group consisting of a C1-C20 alkyl, C1-C20 alkoxy, C1-C20 hydroxyalkyl, C1-C20 aminoalkyl, C1-C20 haloalkyl, C7-C20 aralkyl, C6-C20 aryl groups or a derivative of these groups. Preferably, R is selected from the group consisting of a C1-C12 alkyl, C1-C12 alkoxy, C1-C12 hydroxyalkyl, C1-C12 aminoalkyl, C1-C12 haloalkyl, C7-C14 aralkyl, and C6-C12 aryl groups. In the invention, the number of carbons is noted CXX to CYY or CXX-CYY. For example, a C1-C20 or C1 to C20 alkyl mean an alkyl having a number of carbon ranging from 1 to 20.

The silane type compound may be an alkoxysilane derivative represented by the general formula (II) as follows: R¹ₙSi(OR²)₄₋ₙ where n is 1, 2 or 3, R¹, identic or different, is a C1-C20 alkyl, C1-C20 alkoxy, C2-C20 alkenyl, C6-C20 aryl, C7-C20 aralkyl group or a derivative of these groups, and the substituent R₁ in one molecule may be either all the same or different; R² is a C1-C20 alkyl and. Preferably, R¹ is selected from the group consisting of a C1-C12 alkyl, C1-C12 alkoxy, C1-C12 hydroxyalkyl, C1-C12 aminoalkyl, C1-C12 haloalkyl, C7-C14 aralkyl, and C6-C12 aryl groups.

Silane and polysiloxane can be selected from the group consisting of isobutylmethoxysilane, polydimethylsiloxane, amino functional polydimethylsiloxane, aminoethylaminopropyltrimethoxysilane, octyltriethoxysilane, iso-octyltriethoxysilane, octyltrimethoxysilane, iso-octyltrimethoxysilane, potassium silicone, sodium silicone, potassium methylsiliconate and mixtures thereof. Preferably, silane and siloxane can be selected from the group consisting of polydimethylsiloxane, octyltriethoxysilane, iso-octyltriethoxysilane, octyltrimethoxysilane, iso-octyltrimethoxysilane, potassium methylsiliconate and mixtures thereof.

The salt of fatty acid, the fatty acid being of formula R³COOH wherein R³ is a linear or ramified alkyl comprising a number of carbon ranging from C15 to C48, preferably from C18 to C45, preferably from C20 to C40, and more preferably from C24 to C36 carbon. Preferably, R³ is a linear alkyl.

Advantageously, the salt is a salt of zinc, sodium, calcium, magnesium, manganese, copper or a mixture thereof. In a preferred embodiment, the salt of fatty acid is selected from a salt of stearate, preferably from sodium stearate, calcium stearate or a mixture thereof.

Preferably, hydrophobic additive is selected from calcium stearate, polydimethylsiloxane, octyltriethoxysilane, iso-octyltriethoxysilane, octyltrimethoxysilane, iso-octyltrimethoxysilane, potassium methylsiliconate or mixture thereof.

Preferably, the hydrophobic additive content ranges from 0.01% to 15% by weight, preferentially from 0.05% to 10% by weight, preferentially from 0.1% to 5% and more preferentially from 0.1% to 2% by weight of the total weight of the cement.

Advantageously, hydrophobic additive is a silane with a content ranging from 0.1 to 1% by weight of the total weight of the cement.

Advantageously, hydrophobic additive is a polysiloxane with a content ranging from 0.1 to 1% by weight of the total weight of the cement.

Advantageously, hydrophobic additive is a salt of fatty acid with a content ranging from 0.5 to 1% by weight of the total weight of the cement.

Hydrophobic additive can be added in a dried state or in a liquid state.

For hydrophobic additive in a liquid state, the content is expressed in weight % of solid content in liquid admixture compared to total weight of the cement. Preferably, hydrophobic additive is in liquid state with a solid additive content comprised between 10 and 60 wt.-%, preferably between 20 and 40 wt.-%.

Advantageously, the composition comprises also a cement hydration retarder, preferably more than 0.05% in weight of the cement hydration retarder, preferably more than 0.05% to 6%, preferably from 0.1% to 3%, more preferably from 0.5% to 1%, of the cement hydration retarder, the percentages are expressed in weight compared to the total weight of the cement.

At these dosages, the cement hydration retarder is efficient to postpone hydration of the cement, even at temperature above 20° C., or preferably above 50° C., preferably up to 80° C.

The cement hydration retarder is preferably selected from sodium gluconate, amino tris methylene phosphonic acid (ATMP), saccharose, ethylene diamine tetraacetic acid (EDTA), or mixtures thereof. More preferably, the cement hydration retarder is selected from ATMP, EDTA, or mixtures thereof.

The composition can comprise more than 0.05%, preferably from 0.05% to 2%, preferably from 0.1% to 1%, of gluconate, the percentages are expressed in weight compared to the total weight of the cement.

The composition can comprise more than 0.05%, preferably from 0.05% to 2%, preferably from 0.1% to 1%, of ATMP, the percentages are expressed in weight compared to the total weight of the cement.

The composition can comprise more than 0.05%, preferably from 0.05% to 3%, preferably from 0.1% to 3%, of saccharose, the percentages are expressed in weight compared to the total weight of the cement.

The composition can comprise more than 0.05%, preferably from 0.05% to 2%, preferably from 0.1% to 2%, of EDTA, the percentages are expressed in weight compared to the total weight of the cement.

The composition can further comprise other chemical additive, and in particular a carbonation accelerator. The accelerator can be used to maximize carbonation.

The composition preferably comprises from 0.01% to 6%, preferably from 0.05% to 3%, preferably from 0.1% to 2%, more preferably from 0.1% to 1%, of the carbonation accelerator, the percentages are expressed in weight compared to the total weight of the cement.

The carbonation accelerator is preferably selected from triethylamine (TEA), triisopropanolamine (TIPA), calcium salts, sodium salts, or mixtures thereof.

Calcium salts are preferably selected from Ca(NO₃)₂, CaCl₂ or mixtures thereof.

Sodium salts are preferably selected from NaHCO₃, Na₂CO₃, NaCl or mixtures thereof.

The composition can comprise from 0.05% to 2%, preferably from 0.1% to 1% of TEA, the percentages are expressed in weight compared to the total weight of the cement.

The composition can comprise from 0.05% to 2%, preferably from 0.1% to 1%, of TIPA, the percentages are expressed in weight compared to the total weight of the cement.

The composition can comprise from 0.1% to 3% of calcium salts, the percentages are expressed in weight compared to the total weight of the cement.

The composition can comprise from 0.1% to 1% of sodium salts, the percentages are expressed in weight compared to the total weight of the cement.

The composition comprises cement, where the cement is as defined previously.

Preferably, the cement comprises at least 20%, preferentially at least 50%, in weight compared to the total weight cement, of Portland clinker.

Preferably the cement is selected from CEM I, CEM II or CEM III, as defined in the standard NF-EN-197-1 of April 2012. More preferably the cement is selected from CEM I or CEM III. A CEM III cement is preferably selected from CEM III/A or CEM III/B.

The cement may comprise at least 95%, in weight compared to the total weight cement, of Portland clinker. The cement is thus a CEM I cement.

The cement may comprise mineral component selected from granulated blast furnace slag, pozzolanic materials, fly ashes, burnt shale, limestone, silica fume and combinations thereof.

Pozzolanic materials include natural pozzolana, natural calcined pozzolana, such as metakaolin, and combinations thereof. Fly ashes include silicious fly ash, calcareous fly ash, and combinations thereof.

The cement may comprise at least 65% to 94% of Portland clinker and from 6% to 35% of mineral component selected from granulated blast furnace slag, pozzolanic materials, fly ashes, burnt shale, limestone, silica fume and combinations thereof, the percentages being expressed in weight compared to the total weight cement. The cement is thus a CEM II cement.

The cement may comprise from 35% to 64% of Portland clinker and from 36% to 65% of blast furnace slag, the percentages being expressed in weight compared to the total weight cement. The cement is thus a CEM III/A cement.

The cement may comprise from 20% to 34% of Portland clinker and from 66% to 80% of blast furnace slag, the percentages being expressed in weight compared to the total weight cement. The cement is thus a CEM III/B cement.

The addition of mineral component further lowers the overall carbon footprint.

The composition of step a) also comprises water and preferably has a weight water/cement ratio below 0.8, preferably below 0.7 and more preferably below 0.6. The composition of step a) has preferably a weight water/cement ratio ranging from 0.15 to 0.8, preferably ranging from 0.15 to 0.7, and more preferably ranging from 0.2 to 0.6.

The composition may also comprise admixtures for rheology, in particular a water reducer, such as a plasticizer or a super-plasticizer.

The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein as well as superplasticizers.

Superplasticizers can be selected from sulfonated condensates of naphthalene formaldehyde (generally a sodium salt), sulfonate condensates of melamine formaldehyde, modified lignosulfonates, polycarboxylates, e.g. polyacrylates (generally sodium salt), polycarboxylate ethers, polycarboxylate esters, copolymers containing a polyethylene glycol grafted on a polycarboxylate, sodium polycarboxylates-polysulfonates, and combinations thereof. In order to reduce the total amount of alkaline salts, the superplasticizer may be used as a calcium salt rather than as a sodium salt.

Preferably, the composition of step a) does not comprise imidazoline quaternary ammonium salt.

Preferably, the composition of step a) is selected from a cement paste, a mortar, or a concrete. The method can be applied to all reinforced precast concrete products including, but not limited to, slabs, beams, pre-stressed slabs and beams, walls.

When the composition is a mortar or a concrete composition, the composition will further comprise aggregates.

Aggregates include sand (whose particles generally have a maximum size (Dmax) of less than or equal to 4 mm), and gravel (whose particles generally have a minimum size (d min) greater than 4 mm and preferably a Dmax less than or equal to 20 mm).

The aggregates include calcareous, siliceous, and silico-calcareous materials. They include natural, artificial, waste and recycled materials.

During step a), the components of the composition are mixed under conventional manner, for example in a mixer such as a Perrier mixer. If need be, the sand and/or aggregates can be pre-saturated with water before mixing, to allow a more accurate control of the water/cement ratio in the composition.

Reinforcing elements are added to the composition of step a) in function of their nature according to the knows methods of the skilled person. For example, in the case of small reinforcing elements such as steel fiber, they can simply be added during the mixture of the components of the composition of step a). In the case of big reinforcing elements such as steel rebar or steel mesh, the composition of step a) can be spread on the reinforcing elements.

The mortar or concrete composition can be directly casted or spread or used in a 3D-print system, in all case in plant or on-site.

Preferably, the mortar or concrete composition is spread in a mold, then unmolded before step b) and the solid is placed on a support. If need be, the composition is slightly pre-dried before unmolding it; meaning that the pre-drying is the minimal drying required for unmolding.

Preferably, the mortar or concrete composition is compacted, for example using a vibrating press for concrete mixes that are relatively dry. Compacting the composition may allow to obtain solid samples which can be handled and directly placed in the chamber of step without pre-drying.

Thus, the method can comprise a step, prior to the optional hardening step and/or to the optional pre-drying step, of compacting or molding, or otherwise preparing in a solid form, the composition of step a). A solid form is a cohesive shape that can be handled. If molded, the composition is unmolded before step b).

### Optional Hardening Step

The method can further comprise an optional hardening step during which the compressive strength of the composition of step a) is increasing. This hardening step is carried out without CO₂ addition. Advantageously, the hardening step is carried out at a relative humidity above 80° %, preferably above 90° % and preferably the relative humidity can be until 100% at the temperature and pressure of hardening step. In that case, the hardening step is a wet curing step of the composition prepared in step a). During this wet curing step, hydration of cement occurs and the compressive strength increases.

Preferably, hardening step is performed for at least 24 hours. The hardening step can last several days, including up to 28 days, and is preferably done for a duration of maximum 2 days for practical and economic reasons.

Preferably, hardening step is performed at a temperature comprises between 10° C. and 100° C., preferably between 15° C. and 90° C. Preferably, hardening step is carried out at atmospheric pressure.

Preferably, hardening step is performed at atmospheric pressure (1 013.25 hPa).

One understands that the optional hardening step is performed after step a) and before step b).

### Optional Pre-Drying Step

Optionally, the composition of step a) or the hardened composition obtained after the optional hardening step is submitted to a pre-drying step. One understands that the optional pre-drying step is performed after step a) and before step b).

The pre-drying step consists in heating the composition to evaporate a part of the water. Pre-drying step is carried out without CO₂ addition.

Advantageously, the composition is not fully dried during pre-drying step.

In an embodiment, the method comprises a pre-drying step but does not involve the optional hardening step discloses above. Accordingly, the composition of step a) is pre-dried.

Preferably, pre-drying step is conducted until the composition has a water content ranging from 0.1 to 0.3, preferably from 0.1 to 0.2. This water content is expressed in terms of remaining mass of liquid water after drying, normalized by the mass of cement in the composition.

Preferably, mass loss is linear with time.

The pre-drying step can be conducted in any suitable drying device. For example, the composition is placed in a climatic chamber. The drying rate is varied by changing the temperature and relative humidity in a market available climatic chamber. Preferably, the conditions are chosen to allow homogeneity of drying, i.e. by controlling that the mass loss is linear with time.

Preferably, pre-drying step is conducted at a temperature ranging from 20 to 80° C.

Preferably, pre-drying step is conducted at a controlled relative humidity, ranging from 10 to 95%. The drying is stopped once a targeted water content, preferably as defined above, is reached: the drying duration may vary from 15 minutes to a few days depending on conditions and on sample size.

In another embodiment, the method comprises hardening and pre-drying steps. Accordingly, the hardened composition is pre-dried.

Preferably, pre-drying step is conducted at a temperature ranging from 20 to 105° C.

Preferably, pre-drying step is conducted at a controlled relative humidity, ranging from 40 to 80%, preferably ranging from 50 to 80% and more preferably from 50 to 60%.

The pre-drying step can be conducted in any suitable drying device. For example, the composition of step a) is placed in a climatic chamber.

Preferably, pre-drying step is conducted for a duration comprised between 10 minutes and up to several hours or days, for example 5 hours depending on pre-drying conditions, so as to reach the water content ranging from 0.1 to 0.3, preferably from 0.1 to 0.2, expressed in terms of remaining mass of liquid water after drying, normalized by the mass of cement in the composition.

### Step b) of Carbonation

The method then comprises a step b) of carbonation of the reinforced composition of step a), which may have been hardened and/or pre-dried as disclosed above. Step b) is carried out in presence of CO₂ gas having a CO₂ content higher than 500 ppm.

Advantageously, carbonation with a CO₂ gas having a CO₂ content higher than 500 ppm allows a significant CO₂ binding capacity, with a CO₂ uptake preferably greater than 0.15, more preferably greater than 0.20.

The CO₂ uptake is the value Δm_{CO2} calculated according to the equation 5 disclosed in the examples. In addition, the compositions obtained by the methods show good mechanical performance.

The disclosed method allows to obtain carbonated composition, with significant CO₂ binding capacity and show good mechanical performance while using standard OPC.

When the hardening step described above is not implemented or when the composition is not fully hardened after that step, then hardening of the composition occurs during this step b) of carbonation. Thus, the hardening of the composition is performed prior to step b) and/or during step b) of carbonation.

According to the invention, the carbonation step b) is carried out with a CO₂ gas having a CO₂ content higher than that of the air which is responsible for the natural carbonation. Thus, the carbonation step b) of the method of the invention can also be called accelerated carbonation since the carbonation step b) is quicker than the natural carbonation.

The carbonation step b) is performed in presence CO₂ gas having a CO₂ content higher than 500 ppm, preferably higher than 1000 ppm. The CO₂ concentration in the gas can range from 0.1% to 100%, preferably from 1% to 90%, preferably from 3% to 80%, preferably from 5% to 70%, more preferably from 10% to 50%; in volume compared to the total volume of the dry gas.

The CO₂ gas can be any kind of gas containing CO₂ for example obtained from combustion. Those gas include an industrial waste gas containing CO₂ such as CO₂ gas directly exiting cement kilns, or CO₂ gas exiting waste incinerators, or CO₂ gas contained in the exhaust gases emitted by vehicles.

In the embodiment where the CO₂ gas is exhaust gas, in particular CO₂ gas directly exiting cement kilns. The CO₂ concentration in the gas can range from 5% to 100%, preferably from 10% to 50%, more preferably 10% to 30%; in volume compared to the total volume of the dry gas.

The carbonation step b) is performed by contacting the CO₂ gas with the composition disclosed above. Said contacting can be realized with or without a specific equipment. The equipment can be anyone known by the skilled person in the art, for example in a carbonation chamber such as an incubator, a tank.

The carbonation step b) can be performed either in a curing chamber or in fresh concrete used in ready-applications, e.g. carbonation during transport of fresh concrete in ready-mix trucks, or carbonation of poured concrete on the job site. The carbonation step b) can be done in a plant or on the construction site. The carbonated reinforced construction element can also be a pre-cast element which is carbonated in a plant or on site.

Preferably, step b) is carried out at a temperature ranging from 20° C. to 100° C., preferably from 40° C. to 90° C., preferably from 50° C. to 85° C. and more preferably from 60° C. to 80° C. Advantageously, particularly when the method comprises the hardening step previously disclosed, step b) is carried out at a temperature ranging from 10° C. to 100° C., preferably from 15° C. to 90° C.

Preferably, step b) is performed at a pressure ranging from 600 hPa to 4 200 hPa, preferably from 700 hPa to 3 500 hPa, preferably from 800 to 3 000, preferably from 900 to 2 500 hPa, preferably 950 to 2 000 hPa, preferably from 1000 to 1 500 hPa, preferentially from 1 010 hPa to 1 100 hPa, and more preferably at atmospheric pressure (1 013.25 hPa).

Advantageously, the carbonation step b) is carried out at a relative humidity above 50° %.

In the embodiment where the method comprises the hardening step disclosed above, the carbonation step b) is preferably carried out at a relative humidity ranging from 60° % to 100%, more preferably from 80° % to 100%. In that embodiment, the pre-drying step can be performed or not.

In the embodiment where the method does not involve the optional hardening step disclosed above, the carbonation step b) is advantageously carried out at a relative humidity above 80° %, preferably above 90° % and preferably the relative humidity can be until 100% at the temperature and pressure of step b). In that embodiment, the pre-drying step can be performed or not.

In all embodiments, the CO₂ gas may be pre-saturated with water vapor before introduction to step b). The relative humidity (RH) of the CO₂ gas is preferably from 60% to 100%, at the temperature and pressure of feeding CO₂ gas.

Preferably, step b) is carried out in a chamber of an incubator. Advantageously, the chamber of the incubator contains at least one inlet and one outlet. The pre-dried composition is carbonated, in a carbonation step, by feeding into the chamber of the incubator, through the inlet, a flow of CO₂ containing gas. Variations of the CO₂ concentration in the chamber of the incubator are preferably kept below 10% of a reference value during the whole carbonation step. Preferably, during the carbonation step, the pressure within the chamber of the incubator is atmospheric pressure (1 013.25 hPa) or with slight overpressure, the relative humidity within the chamber of the incubator is above 80° % and the temperature within the chamber of the incubator is ranging from 20° C. to 80° C. The slight overpressure can be of 1000 to 3000 Pa. The CO₂ gas can thus be fed at a pressure ranging from 1 013.25 hPa to 1 043.25 hPa, preferably from 1 013.25 hPa to 1 023.25 hPa.

In all embodiments, the composition of step a) eventually after hardening step and/or pre-drying step is advantageously placed in an incubator, and more precisely into an interior space of the incubator, called the chamber of the incubator. The chamber of the incubator can also be called a curing chamber or carbonation chamber or vacuum oven. The chamber of the incubator is preferably a closed volume. In the incubator's chamber, the composition is isolated from the external environment of the incubator, and in particular from the atmospheric air. Preferably the chamber is a tight chamber. In particular, the leakage rate is below 100 hPa/day. The incubator comprises an access closed by a door, a hatch or any other barrier that allows ingress into and egress from the chamber, while ensuring that the chamber is still isolated when the access is closed. The access is used for introducing the composition into the curing chamber and for removing it from the curing chamber.

The incubator contains at least one inlet and one outlet terminating in the chamber, and forming gas ducts. The inlet allows introduction of the CO₂ gas into the chamber of the incubator. The outlet allows exit of the CO₂ gas out the chamber of the incubator. Preferably, the incubator contains one inlet and one outlet. The CO₂ concentration of gas at inlet and outlet can be measured with sensors. The gas ducts (inlet/outlet) allow both temperature control and gas control (composition, pressure) within the chamber, for example by varying the flow rate or the properties of the gas.

The incubator can also comprise CO₂ sensors to monitor CO₂ within the chamber, in particular infrared CO₂ meter. The incubator preferably comprises at least one CO₂ sensor at the inlet and one CO₂ sensor at the outlet, for sensing a CO₂ concentration of the gas circulating in the inlet or the outlet, respectively.

The incubator can also comprise temperature sensors to monitor temperature within the chamber.

The chamber of the incubator can be purged of air before starting carbonation, once the pre-dried composition is placed in the chamber and the chamber is closed. For example, a vacuum pump is used to flush the initial air in the chamber of the incubator with the CO₂ gas flow.

Preferably, the chamber may be ventilated. Accordingly, the chamber may comprise fans located at different heights of the chamber, including, if need be, the ceiling of the chamber, to favor gas composition homogeneity in the entire volume of the chamber.

The composition is carbonated in a carbonation step, by feeding into the chamber of the incubator, through the inlet, a flow of CO₂ gas.

The CO₂ gas flow is introduced in the chamber of the incubator, through the inlet, so that the variations of the CO₂ concentration in the chamber of the incubator are kept below 10% of a reference value, preferably below 5% of the reference value. The reference value is fixed on a case-by-case basis. Accordingly, the gaseous CO₂ concentration in the gas within the chamber of the incubator, specifically near the inlet where a CO₂ sensor is placed, is more or less constant. Preferably, the variation of the CO₂ concentration is thus controlled, below the above defined values, during at least 80% of the duration of the carbonation step, preferably during at least 90% of the duration of the carbonation step, more preferably during at least 95% of the duration of the carbonation step, most preferably during the whole carbonation step. Accordingly, the CO₂ gas flow is a continuous flow. Accordingly, the CO₂ gas flow is not interrupted during the carbonation step. The CO₂ gas flow can be interrupted only for calculating CO₂ depletion as detailed below.

Preferably, the gas present in the chamber of incubator has a constant composition during the carbonation step, especially during the whole carbonation step. Constant means a variation kept below 10% of a reference value, preferably below 5% of the reference value. Accordingly, during the carbonation step, especially during the whole carbonation step, the sample is exposed within the chamber to a CO₂-rich confined atmosphere having a constant composition. Preferably, the flow of CO₂ containing gas is fed through the inlet into the chamber of the incubator at a flow rate of 0.5 L_gas/L_sample/h to 5 L_gas/L_sample/h.

The CO₂ gas flow may be pre-saturated with water vapor before injection in the chamber of the incubator. The relative humidity (RH) of the CO₂ gas is preferably from 60% to 100%, at the feeding temperature and feeding pressure.

The CO₂ gas is fed at atmospheric pressure (1 013.25 hPa) or with slight overpressure to sustain constant composition (as defined above) within the chamber. The slight overpressure can be of 1000 to 3000 Pa. The CO₂ gas can thus be fed at a pressure ranging from 1 013.25 hPa to 1 043.25 hPa, preferably from 1 013.25 hPa to 1 023.25 hPa.

The CO₂ gas flow can be heated at a temperature ranging from 20 to 120° C., preferably from 60° C. to 120° C., more preferably from 60° C. to 80° C.

In an embodiment, the CO₂ gas flow is pre-saturated with water vapor before injection in the chamber of the incubator. The relative humidity of the CO₂ gas is preferably from 60% to 100%. The CO₂ gas flow is preferably heated at a temperature higher than chamber temperature, preferably at a temperature ranging from 60° C. to 120° C.

During the carbonation step, the pressure withing the chamber of the incubator is atmospheric pressure+/−100 hPa.

During the carbonation step, the relative humidity within the chamber of the incubator is above 50%, preferably from 60° % to 100%, more preferably from 80° % to 100%, or preferably above 80° %, preferably above 85%, preferably above 90° %. The relative humidity can be until 100%. The relative humidity can be controlled with a tank of deionized water laid on the bottom of the chamber of the incubator. The relative humidity is here considered at the temperature within the chamber and the pressure within the chamber.

During the carbonation step, the temperature within the chamber of the incubator is ranging from 20° C. to 100° C., preferably from 20° C. to 90° C., preferably from 20° C. to 80° C., or preferably from 40° C. to 90° C., preferably from 50° C. to 85° C. and more preferably from 60° C. to 80° C.

During the carbonation step, the chamber is preferably ventilated. Ventilation within the chamber of the incubator aims to favor gas composition homogeneity in the entire volume of the chamber. In particular, ventilation aims to avoid local condensation issues due to the relative humidity.

The duration of carbonation step is variable, generally from 1 hour to 3 days.

In an embodiment where the hardening step as disclosed above is not performed prior to step b) (and thus hardening occurs during the carbonation step), the duration of carbonation step is generally from 1 hour to 1 days.

In another embodiment where the hardening step as disclosed above is performed prior to step b), the duration is generally from 1 hour to 3 days, preferably from 6 hours to 3 days.

The duration of the carbonation step can be regulated by measuring CO₂ depletion. CO₂ depletion is calculated by closing the CO₂ inlet for a 2 to 5 minutes and measuring the CO₂ depletion rate during that time, since the chamber of the incubator is tight during that duration.

The duration of the carbonation step can be regulated by determining average maturity of cement in composition. That determination can be done automatically by calculating the integral of point measurement of mass flow rate.

Once carbonation step is ended, the composition is removed from the chamber of the incubator. The composition can then be stored or used directly. The composition can be placed in a post water condensing unit, after exiting the incubator and before use.

Advantageously, after the carbonation step, a final drying step can be included to fully remove free water and improve performance. The final drying step can be performed at a temperature ranging from 40° C. to 115° C., preferably ranging from 60 to 110° C. and more preferably ranging from 80° C. to 105° C. The final drying step can be performed for a duration in the range of 0.5 hours to 3 hours. The final drying step can be performed at atmospheric pressure.

Advantageously, the mass of composition obtained by the method increases, compared to the initial mass of the composition placed in the chamber of the incubator, due to water uptake and CO₂ uptake.

The method of measurement of hydration and carbonation amount is disclosed in the examples and can be applied generally to any composition obtained by the disclosed method.

Accordingly, the invention is also directed to a method for storing carbon dioxide in a reinforcing construction element by carbonation of a cement composition while preventing corrosion of said element, comprising the consecutive steps of:
a) preparing a composition containing a cement, water and chemical additive(s) as disclosed above;
an optional hardening step of the composition prepared in step a),
an optional pre-drying step of the hardened composition or of the composition of step a); then
b) placing the composition of step a) or the hardened and/or pre-dried composition in a chamber of an incubator to perform a carbonation step, wherein
   the chamber of the incubator contains at least one inlet and one outlet,
   the composition is carbonated, in a carbonation step, by feeding into the chamber of the incubator, through the inlet, a flow of CO₂ containing gas
   variations of the CO₂ concentration in the chamber of the incubator are kept below 10% of a reference value during the whole carbonation step,
   during the carbonation, the pressure withing the chamber of the incubator is atmospheric pressure or with slight overpressure as disclosed above, the relative humidity within the chamber of the incubator is above 50% and the temperature within the chamber of the incubator is ranging from 20° C. to 100° C.
   characterized in that the chemical additive(s) in the composition of step a) comprise more than 0.01% in weight, preferably more than 0.05% in weight, compared to the total weight of the cement, of hydrophobic additive.

The preferred embodiments previously disclosed also apply here.

Accordingly, the invention is also directed to a method of preventing corrosion of metal reinforcing element in a reinforced carbonated construction element, comprising the consecutive steps of:
a) preparing a composition containing a cement, metal reinforcing elements, water and hydrophobic additive;
an optional hardening step of the composition prepared in step a),
an optional pre-drying step of the hardened composition or of the composition of step a); then
b) a carbonation step of the composition in presence of CO₂ gas having a CO₂ content higher than 500 ppm, the carbonation step is as disclosed above
   characterized in that the composition of step a) comprises more than 0.01% in weight, preferably more than 0.05% in weight, compared to the total weight of the cement, of hydrophobic additive.

The composition is as disclosed previously. Steps a) and b), hardening step and pre-drying step are as disclosed previously. All embodiments disclosed previously apply.

The following non-restrictive examples illustrate embodiments of the invention.

### EXAMPLES

In all examples, % are expressed in weight compared to the total weight of the cement, except specific mention to the contrary.

When a commercial product is available in solution/dispersion form, the content in all examples is expressed by reference to its dry active content.

The abbreviation “cem” means cement. “g_cem” means gram of cement.

Samples are pre-slab reinforced carbonated concretes prepared with compositions presented in table 1.

TABLE 1
concrete composition

| | Comparative | In accordance with the invention | |
|---|---|---|---|
| | Concrete | Concrete | Concrete |
| | composition 1 | composition 2 | composition 3 |
| CEM I kg/m³ | 351 | 351 | 351 |
| Sand 0/1 [mm] kg/m³ | 180 | 180 | 180 |
| Sand 2 0/4[mm] kg/m³ | 652 | 652 | 652 |
| Aggregate 4/10[mm] kg/m³ | 963 | 963 | 963 |
| Water/CEMI (wt/wt) | 0.55 | 0.55 | 0.55 |
| Saccharose(wt % of the cement) | 1 | 1 | 1 |
| Triethanolmamine (wt % of the | 1 | 1 | 1 |
| cement) | | | |
| Premia 196 (wt % of the cement) | 1.75 | 1.75 | 1.75 |
| Calcium Stearate (wt % of the | | 1 | |
| cement) | | | |
| Polysiloxane (wt % of the cement) | | | 1 |

CEM I 52.5 N from le Teil cement plant (Lafarge France)
Hydrophobic additive: Calcium Stearate from the commercial product CD205 by Echem (50% dispersion of dry mass)
Hydrophobic additive: polysiloxane from the commercial product SILRES®BS 7939 by Wacker
superplasticizer provided by Chryso under the commercial name Chryso® Premia 196 with dosage at 1.75 wt %

The concrete composition comprises steel rebar as metal reinforcing elements.

### Materials for Electrochemical Measurements

### Instrumented Samples

A 7*7*28 cm molds is used to prepare the instrumented sample.

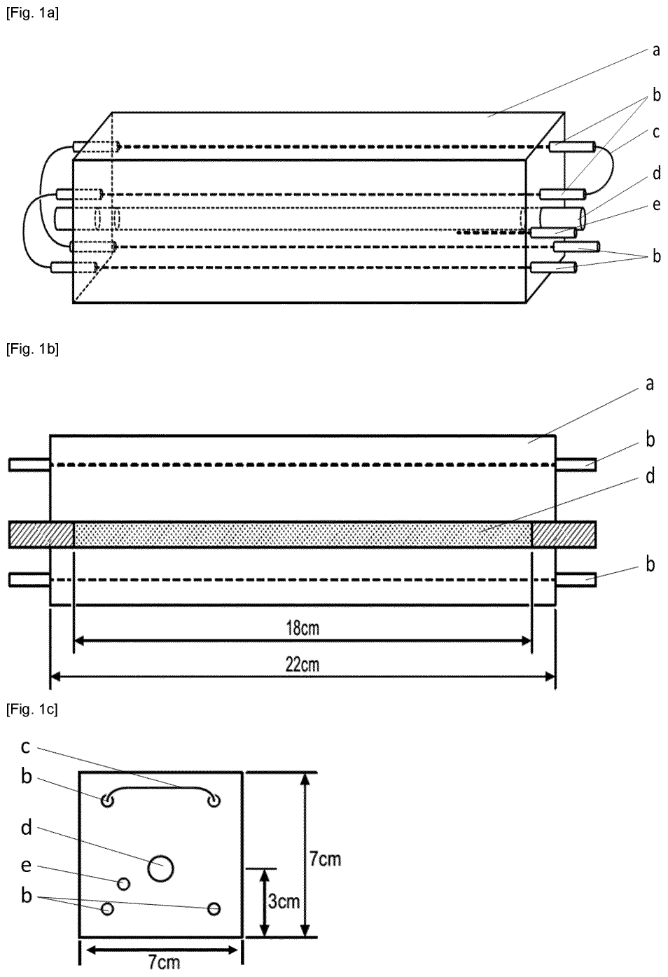

FIGS. 1a to 1c are a schematic representation of the samples with the position of the electrodes in mold having a size of 7*7*28 cm.

In each of FIGS. 1a to 1c, the following legend is used:
a: is concrete sample
b: is counter electrodes made of stainless steel and connected with copper wires (c).
d: is the working electrode corresponding of steel rebar having a diameter of 8 mm.
e: is the reference electrode mode of Ag/AgCl.

Samples (a) are prisms with length of 22 cm. The four faces (sides) of the prism have been protected to the air and the humidity with a resin Sicomin SR434. Only the top face and the bottom face of the prism are kept free of resin for the wetting drying cycles.

A PU foam 2 cm thick, was used to fix the different electrode at the correct place.

Before pouring concrete, the 7*7*28 cm molds is equipped with a wire for the counter electrode, a steel rebar as working electrode and a foam that hold both types of electrodes.

### Electrodes are as Follows

Steel rebar as working electrode (WE):
made of reference FeE500 steel used for reinforcing concrete
brushed and cleaned (ethanol)
connected by and electric wire
2 cm of steel is protected within the concrete so we have 18 cm of exposed steel within concrete

### Counter Electrode (CE):

stainless steel wire of 1.6 mm in diameter
each wire is connected to the next one outside of the sample
position of CE in each of the 4 corners, on a line between the corner and the center of the WE, at 1.5 cm from the corner.

### Reference Electrode (RE):

Ag/AgCl wire in metallic tube to ensure rigidity
Sensitive surface at 4 cm from the 7*7 lateral surface
Positioned at the same depth from the bottom/top surface of the sample, i.e. in the same plane as the working electrode, parallel to the top and bottom faces.

### Process of Carbonation of Samples 1 to 3

The carbonation is a two steps process. The first step is a pre-drying step without CO₂ gas flow addition and the second step is a carbonation step at least at 85% relative humidity. At the end of the carbonation step the composition is further hardened.

### Pre-Drying Step

The instrumented samples disclosed above are pre-dried at a temperature of 80° C. in molds for 2 hours then 2 more hours after demolding to reach a Water/CEMI ratio of 0.35.

### Carbonation Step

After the pre-drying step the samples are introduced in a market available vacuum oven, which allows both temperature control and gas control (composition, pressure) thanks to gas connections (inlet/outlet).

This oven is called the chamber of the incubator.

Here the gas used is a CO₂ gas flow. The laboratory is equipped with pure CO₂ gas. The CO₂ gas flow may be pre-saturated with water vapor before injection in the chamber of the incubator. A vacuum pump is used to flush the initial air in the chamber of the incubator with the CO₂ gas flow.

The relative humidity is also controlled with a tank of deionized water laid on the bottom of the oven. The relative humidity is above 85%, the temperature is 70° C.

Further information on the curing process:

### Gas:

Pressure: atmospheric pressure, with slight overpressure to sustain flow (flow with one input, one output)
CO₂: 100% by volume of the dry gas composition, at 1 bar
Temperature: 70° C.

### Chamber:

Ventilation 410 m³/h
Fan location all along the height of the chamber to favor cells
Tight chamber with control leakages (qualification)

### Pre Carbonation Unit:

Presaturation of gas with water at a temperature higher than chamber temperature

### Sensing:

Inlet and Outlet flow
CO₂ concentration of dry gas at inlet and outlet is measured
CO₂ sensors to monitor CO₂ within chamber (N sensor per unit volume)
Temperature

### Regulation:

CO₂ depletion in dynamic conditions (from inlet/outlet data)
CO₂ depletion rate in short term static conditions
Automatic determination of average maturity of cement in elements
Integral of point measurement of mass flow rate (dynamic and static)

### Strength Measurement

Concrete strength is tested according to NF EN 12390-3:2019:
Compressive strength (CS) tests are performed on 10*10*10 samples

### Electrochemical Measurements

### Corrosion Potential Ecorr

The corrosion potential Ecorr is measured against an Ag/AgCl reference electrode.

### Linear Polarization Resistance (LPR)

The LPR is measured by polarizing the sample at 10 mV/min in three steps:
1. From Ecorr down to Ecorr −10 mV
2. From Ecorr −10 mV up to Ecorr+10 mV
3. From Ecorr+10 mV down to intial Ecorr

The slope of current vs applied potential is taken during the second step, in the linear domain between [Ecorr−Ecorr+10 mV] range.

### Resistivity (Re)

The impedance of the steel concrete interface is measured for the frequency range from 10 kHz down to 0.1 Hz. The impedance is often plotted in the so-called Nyquist plot, i.e., the imaginary impedance Zim as function of the real impedance Zre for the whole frequency range.

The pure ohmic resistance (i.e. when Zim=0) in the high frequency domain is taken as the resistivity of concrete between the reference electrode and the working electrode.

Calculation of Corrosion Rate from LPR and Re

As demonstrated by Alonsa et al (Alonso C, Andrade C, Gonzalez JA (1988) Relation between resistivity and corrosion rate of reinforcements in carbonated mortar made with several cement types. Cement and Concrete Research 18 (5), 687-698), the measurement of the resistivity of the concrete is proportional of the steel rebar corrosion.

The linear polarisation resistance (LPR) is the low frequency impedance of the interface: it corresponds to contribution of both the resistivity Re and charge transfer resistance Rt at the steel/concrete interface. The corrosion rate (Icorr) is proportional to the inverse Rt, the constant B has a value of 26 mV, which corresponds to Tafel coefficients of the anodic (βa) and cathodic (βa) polarisation curve of 120 mV/dec. «A» is the surface of the corroding steel.

$$\begin{matrix}Equation 1 & \\ LPR = Re + Rt & ( 1 )\end{matrix}$$

$$\begin{matrix}Equation 2 & \\ Icorr = B / ( Rt * A ) & ( 2 )\end{matrix}$$

### Method of Measurement of Hydration and Carbonation Amount by Loss-On-Ignition

The total mass gain (Δm, see eq. (3)) is related to both bound water (Δm_{H2O}) and bound CO₂ (Δm_{CO2}) with respect to the cement [g/g of cement].

After carbonation, the samples are dried at 105° C. to get the final dry mass noted m_{f,dry}, expressed in grams [g].

The mass of the samples after mixing and before carbonation is known, it is noted m_{0,wet} and expressed in grams [g].

The mass of the solid, i.e. the dry mass, is calculated from initial mix composition, it is noted m_{0,dry} and expressed in grams [g].

The weight fraction of cement in the solid mix is known (see Table 1), it is noted m_{cem} and is a mass ratio in [g/g].

$$\begin{matrix}Equation 3 & \\ Δ m = ( {m}_{f dry} - {m}_{0 , dry} ) / {m}_{0 , dry} \times 1 / {m}_{c e m} & ( 3 )\end{matrix}$$

B/CO₂ Mass Gain with Respect to Cement in the Mix:

The bound water content and bound CO₂ content with respect to the mass of samples is also calculated from the measured mass of samples, respectively at 550° C. and 900° C. The mass difference of samples between 105° C. and 550° C. is related to bound water content (see eq. (4)) whereas the mass loss of samples between 550° C. and 900° C. is related to CO₂ content (see eq. (5)).

$$\begin{matrix}Equation 4 & \\ Δ {m}_{H 2 O} = ( {m}_{f , 105} - {m}_{f , 550} ) / {m}_{f , 900} \times {m}_{f , 900} / {m}_{0 , dry} \times 1 / {m}_{c e m} & ( 4 )\end{matrix}$$

$$\begin{matrix}Equation 5 & \\ Δ {m}_{CO 2} = ( {m}_{f , 550} - {m}_{f , 900} ) / {m}_{f , 950} \times {m}_{f , 900} / {m}_{0 , dry} \times 1 / {m}_{c e m} & ( 5 )\end{matrix}$$

### Results

The compressive strength (CS) and CO₂ uptake of each concrete sample are measured on cubes of 10 cm*10 cm*10 cm, following the protocols described above.

TABLE 2
concrete properties

| | Concrete | CS | CO₂ uptake |
|---|---|---|---|
| | composition | [MPa] | [g/g_cem] |
| Sample 1 | 1 | 33.4 | 0.28 |
| Sample 2 | 2 | 30.7 | 0.25 |
| Sample 3 | 3 | 38.2 | 0.25 |

The corrosion is measured by controlling the resistivity of the steel rebar according to the method described above.

The resistivity of concrete sample and the corrosion rate (Icorr) of embedded rebar are measured simultaneously. Table 3 presents the value of resistivity and corrosion rates at the maximum water content (porosity saturated with water). This demonstrates that when the water is forced into concrete, the corrosion rate remains in the intermediate to high range of values according to Andrade et al 2004.

TABLE 3

| | | Resistivity (kOhm) | | |
|---|---|---|---|---|
| | | Sample 1 | Sample 2 | Sample 3 |
| Icorr | 2 | 0.9 | 5.0 | 6.9 |
| (μA/cm²) | 0.6 | 0.5 | 2.2 | 3.8 |

In addition, samples have been submitted to wetting and drying cycles.

Each cycle is composed of a first wetting step and a second drying step period. The duration of wetting and drying for each cycle is given in table 4.

TABLE 4

| Cycle | Sample 1 | | Sample 2 | | Sample 3 | |
|---|---|---|---|---|---|---|
| step | Wetting | Drying | Wetting | Drying | Wetting | Drying |
| 1 | 1 day | 6 days | 1 day | 6 days | 1 day | 6 days |
| 2 | 1 day | 3 days | 1 day | 3 days | 1 day | 3 days |

The wetting step is performed in accordance to ISO15148:2002.

For the drying step the samples are left at a RH of 50%+/−5% and at a temperature of 20° C.

In table 4, the time is measured within a step of a cycle as follow, 1 day of wetting in cycle 2 means the sample has been placed in water for one day since the beginning of wetting.

Corrosion measurement has been performed after 1 day of immersion at cycle 2 or after 1 day of drying at cycle 2. The corrosion rate of samples 2 and 3 according to the method of the invention is much lower than the corrosion rate sample 1. This demonstrates that the use of hydrophobic additive in a concrete composition according to the invention prevents the corrosion of the metal reinforcing element namely the steel rebar.

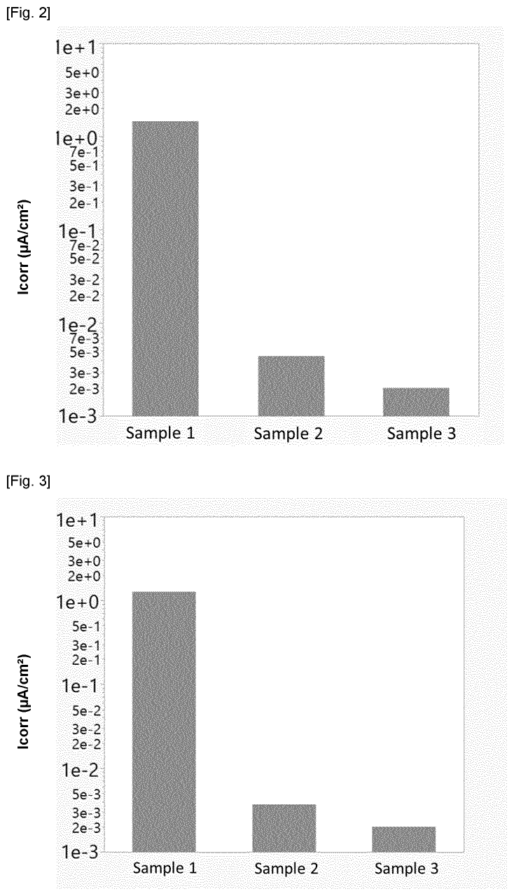

The FIG. 2 illustrates results of the corrosion measurement after 1 day of immersion at cycle 2. Icorr represents the corrosion rate, lower is the Icorr lower is the corrosion.

The FIG. 3 illustrates results of the corrosion measurement after 1 day of drying at cycle 2. Icorr represents the corrosion rate, lower is the Icorr lower is the corrosion.

Thus, a reinforced carbonate construction elements prepared with cement, reinforcing elements and a hydrophobic additive such as calcium stearate, polysiloxane prevents the corrosion of the reinforcing elements (such as steel rebar) while sequestrating CO₂.

1. A method for preventing corrosion of metal reinforcing element and storing carbon dioxide in a construction element, comprising the consecutive steps of:
a) preparing a composition containing a cement, metal reinforcing elements, water and hydrophobic additive selected in the group consisting of silane, polysiloxane, salt of fatty acid or mixtures thereof;
b) a carbonation step of the composition in presence of CO₂ gas having a CO₂ content higher than 500 ppm,
wherein the composition of step a) comprises more than 0.01% in weight, compared to the total weight of the cement, of hydrophobic additive.

2. The method according to claim 1, wherein cement and hydrophobic additive are mixed prior to be introduced into step a).

3. The method according to claim 1, wherein hydrophobic additive is mixed with cement during step a).

4. The method according to claim 1, comprising after the carbonation step b), a final drying step performed at a temperature ranging from 40° C. to 115° C.

5. The method according to claim 1, wherein hydrophobic additive content ranges from 0.01% to 15% by weight of the total weight of the cement.

6. The method according to claim 1, wherein the composition further comprises a cement hydration retarder.

7. The method according to claim 1, wherein the composition further comprises a cement carbonation accelerator selected from triethylamine, triisopropanolamine, calcium salts, sodium salts, or mixtures thereof, the composition comprises from 0.01% to 6% of the carbonation accelerator, the percentages are expressed in weight compared to the total weight of the cement.

8. The method according to claim 1, wherein the cement comprises at least 20% in weight compared to the total weight cement, of Portland clinker.

9. The method according to claim 1, wherein the composition of step a) has a weight water/cement ratio below 0.8.

10. The method according to claim 1, wherein the composition of step a), prior to step b), is submitted to a pre-drying step.

11. The method according to claim 10, wherein the pre-drying step is conducted at a temperature ranging from 20 to 80° C. and at a controlled relative humidity, ranging from 10 to 95%.

12. The method according to claim 1, wherein during the carbonation step, one or many of the following conditions are satisfied:
the temperature is ranging from 20° C. to 100° C.;
the pressure is ranging from 600 hPa to 4 200 hPa;
the relative humidity is above 80° % at the temperature and pressure of step b).

13. The method according to claim 1, wherein step b) is carried out in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure or with slight overpressure, the relative humidity within the chamber of the incubator is above 80° % and the temperature within the chamber of the incubator is ranging from 20° C. to 80° C.

14. The method according to claim 1, wherein hardening of the cement composition is performed simultaneously to carbonation during step b).

15. (canceled)

16. The method according to claim 1, wherein the composition further comprises a cement hydration retarder selected from sodium gluconate, Amino Tris Methylene Phosphonic acid (ATMP), saccharose, or Ethylene Diamine Tetraacetic acid (EDTA), or mixtures thereof.

17. The method according to claim 10, wherein the pre-drying step is conducted until the composition of step a) has a water content ranging from 0.1 to 0.3

18. The method according to claim 10, wherein the pre-drying step is conducted until the composition of step a) has a water content ranging from 0.1 to 0.2.

19. The method for preventing corrosion of metal reinforcing element after accelerated carbonation in a construction element prepared by a method according to claim 1 using of hydrophobic additive selected from silane, polysiloxane, salt of fatty acid or mixtures thereof.
